(19) United States
(12) Patent Application Publication
(10) Pub. No.: US 2019/0182834 A1
(43) Pub. Date: Jun. 13, 2019

(54) TIMING ADVANCE ADJUSTMENT COMMUNICATION

(71) Applicant: Lenovo Innovations Limited (Hong Kong), Hong Kong (CN)

(72) Inventor: Haipeng Lei, Beijing (CN)

(21) Appl. No.: 16/324,742

(22) PCT Filed: Aug. 10, 2016
(86) PCT No.: PCT/CN2016/094486

§ 371 Date: Feb. 11, 2019

(51) Int. Cl. H04W 72/04

(52) U.S. Cl. CPC H04W 72/0446

(57) ABSTRACT

Apparatuses, methods, and systems are disclosed for timing advance adjustment communication. One apparatus includes a transmitter that transmits a first signal to a first device for indicating a first field within a control channel. The first field is used to indicate first timing advance adjustment information for the first device.

### FIELD

The subject matter disclosed herein relates generally to wireless communications and more particularly relates to timing advance adjustment communication.

### BACKGROUND

The following abbreviations are herewith defined, at least some of which are referred to within the following description: Third Generation Partnership Project (“3GPP”), Positive-Acknowledgment (“ACK”), Binary Phase Shift Keying (“BPSK”), Clear Channel Assessment (“CCA”), Cyclic Prefix (“CP”), Channel State Information (“CSI”), Common Search Space (“CSS”), Downlink Control Information (“DCI”), Downlink (“DL”), Downlink Pilot Time Slot (“DwPTS”), Enhanced Clear Channel Assessment (“eCCA”), Evolved Node B (“eNB”), European Telecommunications Standards Institute (“ETSI”), Frame Based Equipment (“FBE”), Frequency Division Duplex (“FDD”), Frequency Division Multiple Access (“FDMA”), Guard Period (“GP”), Hybrid Automatic Repeat Request (“HARQ”), Licensed Assisted Access (“LAA”), Load Based Equipment (“LBE”), Listen-Before-Talk (“LBT”), Long Term Evolution (“LTE”), Machine Type Communication (“MTC”), Multiple Input Multiple Output (“MIMO”), Negative-Acknowledgment (“NACK”) or (“NAK”), Orthogonal Frequency Division Multiplexing (“OFDM”), Primary Cell (“PCell”), Physical Broadcast Channel (“PBCH”), Physical Downlink Control Channel (“PDCCH”), Physical Downlink Shared Channel (“PDSCH”), Physical Hybrid ARQ Indicator Channel (“PHICH”), Physical Random Access Channel (“PRACH”), Physical Resource Block (“PRB”), Physical Uplink Control Channel (“PUCCH”), Physical Uplink Shared Channel (“PUSCH”), Quality of Service (“QoS”), Quadrature Phase Shift Keying (“QPSK”), Radio Resource Control (“RRC”), Random Access Procedure (“RACH”), Resource Spread Multiple Access (“RSMA”), Round Trip Time (“RTT”), Receive (“RX”), Scheduling Request (“SR”), Single Carrier Frequency Division Multiple Access (“SC-FDMA”), Secondary Cell (“SCell”), Shared Channel (“SCH”), Signal-to-Interference-Plus-Noise Ratio (“SINR”), System Information Block (“SIB”), Transport Block (“TB”), Transport Block Size (“TBS”), Time-Division Duplex (“TDD”), Time Division Multiplex (“TDM”), Transmission Time Interval (“TTI”), Transmit (“TX”), Uplink Control Information (“UCI”), User Entity/Equipment (Mobile Terminal) (“UE”), Uplink (“UL”), Universal Mobile Telecommunications System (“UMTS”), Uplink Pilot Time Slot (“UpPTS”), Ultra-reliable and Low-latency Communications (“URLLC”), and Worldwide Interoperability for Microwave Access (“WiMAX”). As used herein, “HARQ-ACK” may represent collectively the Positive Acknowledge (“ACK”) and the Negative Acknowledge (“NAK”). ACK means that a TB is correctly received while NAK means a TB is erroneously received.

In certain wireless communications networks, to avoid resource collision in uplink communication, the networks adopt orthogonal multiple access (“OMA”). The networks may also use scheduling-based uplink transmission so that the orthogonal resources are assigned for different UEs. Moreover, any uplink communication (e.g., except PRACH) may be scheduled and/or controlled by an eNB. As compared to OMA, non-orthogonal multiple access (“NOMA”) may support signal superposition in an orthogonal resource. Accordingly, NOMA may enhance spectrum utilization efficiency, such as in cases of overloaded transmission. Moreover, since NOMA may separate superposed signals at the receiver by using more advanced algorithms, NOMA may support reliable and low latency grant-free transmission. Such transmission may be used for massive MTC and/or URLLC.

In some configurations, there may be no clear difference between autonomous, grant-free, and/or contention based UL transmission. In certain configurations, contention based UL transmission may include autonomous, grant-free, and/or grant-less transmission.

For contention based UL transmission without any timing advance (“TA”) assistance, different UE signals transmitted in a subframe may arrive at a serving eNB with different timing offsets. In OFDM based waveforms, if timing offsets between UEs is larger than the CP, superposed signals of multiple UEs on a resource may increase the eNB blind detection complexity due to interference.

In certain NOMA schemes, UL synchronization support may be used (e.g., timing offsets between UEs may be within a cyclic prefix). In some configurations, a single tone based RSMA may support asynchronous cases. However, single tone based RSMA may not efficiently solve the problem of multi-path channel and integration with MIMO. Moreover, asynchronous NOMA may use a complicated receiver.

### BRIEF SUMMARY

Apparatuses for timing advance adjustment communication are disclosed. Methods and systems also perform the functions of the apparatus. In one embodiment, the apparatus includes a transmitter that transmits a first signal to a first device for indicating a first field within a control channel. In such an embodiment, the first field is used to indicate first timing advance adjustment information for the first device.

In one embodiment, the transmitter transmits a second signal to a second device for indicating a second field within the control channel. In such an embodiment, the second field is used to indicate second timing advance adjustment information for the second device. In a further embodiment, the apparatus includes a receiver that receives a sequence from the first device. In such an embodiment, the sequence is a device specific sequence that distinguishes the first device from another device. In some embodiments, the sequence is generated based on an identification of the first device. In certain embodiments, the sequence occupies one symbol within a transmission time interval.

In some embodiments, the first device transmits data with the sequence in a transmission time interval. In various embodiments, the data and the sequence have a same bandwidth in a frequency domain. In certain embodiments, the first signal indicates the sequence. In one embodiment, the first signal indicates a resource pool for the first device to transmit the sequence. In some embodiments, the first device transmits the sequence on a resource of the resource pool. In various embodiments, the resource pool is shared by multiple devices.

A method for timing advance adjustment communication, in one embodiment, includes transmitting a first signal to a first device for indicating a first field within a control channel. In such an embodiment, the first field is used to indicate first timing advance adjustment information for the first device.

In one embodiment, an apparatus includes a receiver that receives timing advance adjustment information in a field within a control channel.

In one embodiment, the receiver receives a signal indicating the field within the control channel. In a further embodiment, the signal indicates a sequence. In some embodiments, the signal indicates a resource pool for transmitting a sequence. In certain embodiments, the apparatus includes a processor that generates a sequence and a transmitter that transmits the sequence based on the timing advance adjustment information. In such embodiments, the sequence is a device specific sequence that distinguishes the apparatus from another device. In some embodiments, the sequence is generated based on an identification of the apparatus.

In various embodiments, the transmitter transmits the sequence on a resource of a resource pool. In one embodiment, the resource pool is shared by multiple devices. In certain embodiments, the sequence occupies one symbol within a transmission time interval. In some embodiments, the transmitter transmits data with the sequence in a transmission time interval. In various embodiments, the data and the sequence have a same bandwidth in a frequency domain.

A method for timing advance adjustment communication, in one embodiment, includes receiving timing advance adjustment information in a field within a control channel.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for timing advance adjustment communication;

FIG. 2 is a schematic block diagram illustrating one embodiment of an apparatus that may be used for timing advance adjustment communication;

FIG. 3 is a schematic block diagram illustrating one embodiment of an apparatus that may be used for timing advance adjustment communication;

FIG. 4 illustrates one embodiment of communications for timing advance adjustment communication;

FIG. 5 illustrates one embodiment of uplink transmissions;

FIG. 6 illustrates another embodiment of uplink transmissions;

FIG. 7 is a schematic flow chart diagram illustrating one embodiment of a method for timing advance adjustment communication; and

FIG. 8 is a schematic flow chart diagram illustrating another embodiment of a method for timing advance adjustment communication.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

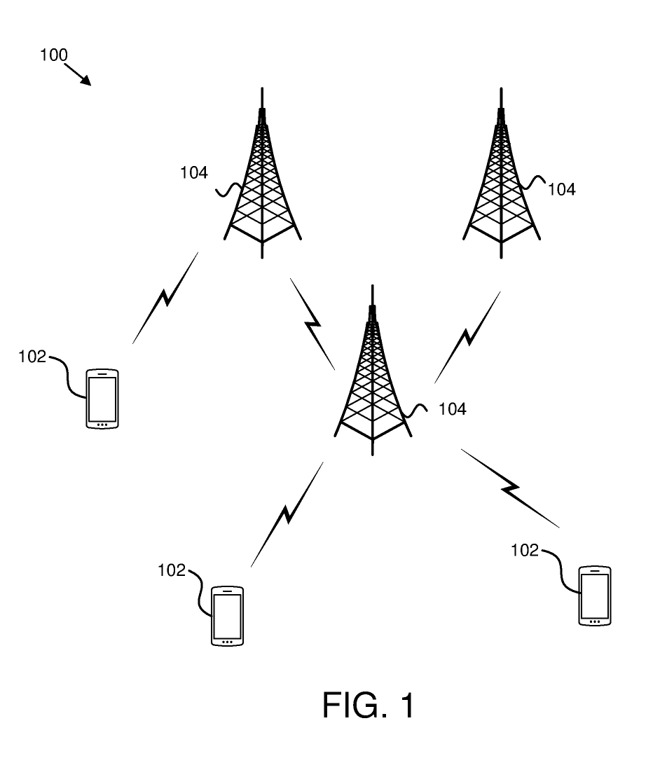

FIG. 1 depicts an embodiment of a wireless communication system 100 for timing advance adjustment communication. In one embodiment, the wireless communication system 100 includes remote units 102 and base units 104. Even though a specific number of remote units 102 and base units 104 are depicted in FIG. 1, one of skill in the art will recognize that any number of remote units 102 and base units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the base units 104 via UL communication signals.

The base units 104 may be distributed over a geographic region. In certain embodiments, a base unit 104 may also be referred to as an access point, an access terminal, a base, a base station, a Node-B, an eNB, a Home Node-B, a relay node, a device, or by any other terminology used in the art. The base units 104 are generally part of a radio access network that includes one or more controllers communicably coupled to one or more corresponding base units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the LTE of the 3GPP protocol, wherein the base unit 104 transmits using an OFDM modulation scheme on the DL and the remote units 102 transmit on the UL using a SC-FDMA scheme. More generally, however, the wireless communication system 100 may implement some other open or proprietary communication protocol, for example, WiMAX, among other protocols. The present disclosure is not intended to be limited to the implementation of any particular wireless communication system architecture or protocol.

The base units 104 may serve a number of remote units 102 within a serving area, for example, a cell or a cell sector via a wireless communication link. The base units 104 transmit DL communication signals to serve the remote units 102 in the time, frequency, and/or spatial domain.

In one embodiment, a base unit 104 may transmit a first signal to a first device for indicating a first field within a control channel. In such an embodiment, the first field may be used to indicate first timing advance adjustment information for the first device. Accordingly, a base unit 104 may receive timing advance adjustment information.

In another embodiment, a remote unit 102 may receive timing advance adjustment information in a field within a control channel. Accordingly, a remote unit 102 may receive timing advance adjustment information.

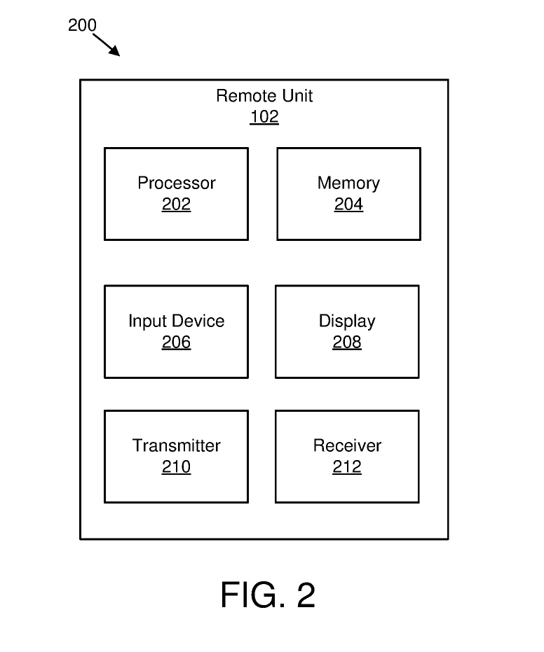

FIG. 2 depicts one embodiment of an apparatus 200 that may be used for timing advance adjustment communication. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212. In certain embodiments, the processor 202 may generating a sequence for transmissions.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to an indication to be provided to another device. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

The transmitter 210 is used to provide UL communication signals to the base unit 104 and the receiver 212 is used to receive DL communication signals from the base unit 104. In one embodiment, the transmitter 210 is used to transmit a sequence. In certain embodiments, the receiver 212 may be used to receive timing advance adjustment information in a field within a control channel. Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

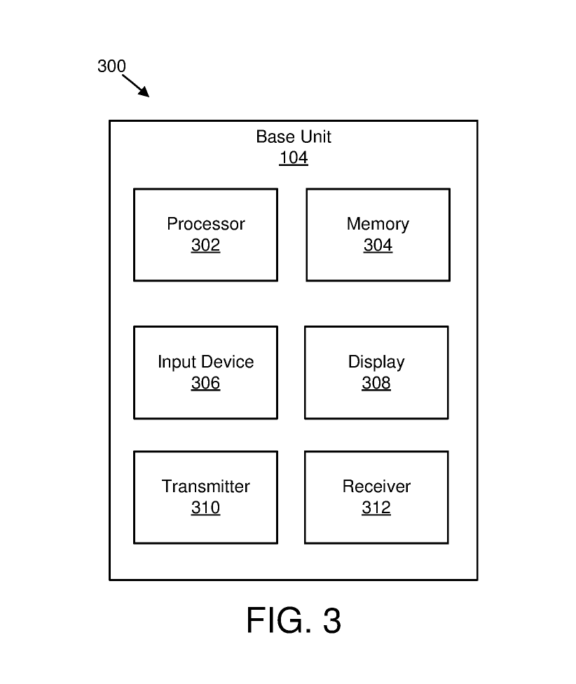

FIG. 3 depicts one embodiment of an apparatus 300 that may be used for timing advance adjustment communication. The apparatus 300 includes one embodiment of the base unit 104. Furthermore, the base unit 104 may include a processor 302, a memory 304, an input device 306, a display 308, a transmitter 310, and a receiver 312. As may be appreciated, the processor 302, the memory 304, the input device 306, and the display 308 may be substantially similar to the processor 202, the memory 204, the input device 206, and the display 208 of the remote unit 102, respectively.

The transmitter 310 may also be used to transmit a first signal to a first device for indicating a first field within a control channel. In such an embodiment, the first field is used to indicate first timing advance adjustment information for the first device. The receiver 312 is used to receive a sequence. Although only one transmitter 310 and one receiver 312 are illustrated, the base unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

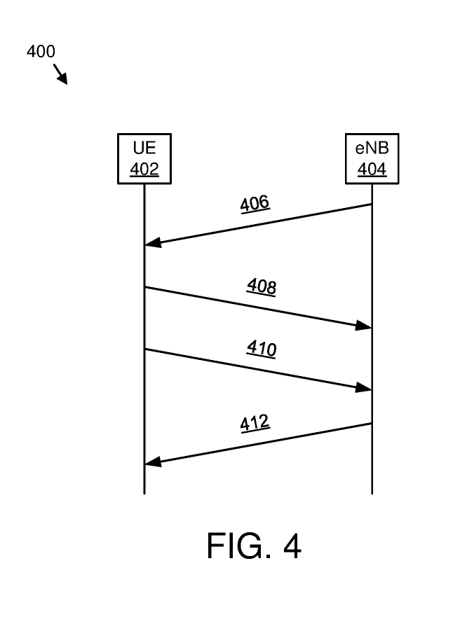

FIG. 4 illustrates one embodiment of communications 400 for timing advance adjustment communication. Specifically, communications 400 between a UE 402 and an eNB 404 are illustrated. A first communication 406 may include configuration information transmitted from the eNB 404 and received by the UE 402. In some embodiments, the configuration information is indicated by RRC signaling. The configuration information may include an indication of: a first field within a control channel used to indicate first timing advance adjustment information for a first device; a second field within the control channel used to indicate second timing advance adjustment information for a second device; a sequence to be used for transmissions; a resource to be used for transmissions; and/or a resource pool to be used for transmissions.

A length of the first and/or second field (e.g., number of bits) may be fixed in a specification or determined by the eNB 404. In certain embodiments, the eNB 404 may schedule a DL transmission and indicate timing advance adjustment information in the scheduled DL transmission. The scheduled DL transmission may include the timing advance adjustment information in a medium access control (“MAC”) element. In some embodiments, the scheduled DL transmission may occur infrequently, such as when used with MTC.

In certain embodiments, the sequence may be a device (e.g., UE, remote unit 102) specific sequence so that each device that communicates with the eNB 404 has a unique sequence. Accordingly, the eNB 404 may be able to determine which communications from a particular device (e.g., distinguish between different devices). Specifically, the sequence may be a device specific sequence for the UE 402. In one embodiment, the sequence may be a constant amplitude zero autocorrelation (“CAZAC”) sequence which may facilitate a low peak to average power ratio (“PAPR”). In certain embodiments, the sequence may be mapped by device identification, such as by a one-to-one mapping relationship.

The first communication 406 may configure a resource pool for the device specific sequence transmission. A resource period, a TTI offset, an occupied frequency bandwidth, and/or frequency position may be indicated by the first communication 408.

A second communication 408 includes the sequence being transmitted from the UE 402 (e.g., remote unit 102) and received by the eNB 404 (e.g., base unit 104). In various embodiments, the UE 402 may generate the sequence and transmit the sequence based on information from the first communication 406. In some embodiments, the sequence may be generated based on an identification of the UE 402. In certain embodiments, the sequence may occupy one symbol (e.g., have one symbol duration). In various embodiments, the sequence may occupy one or more symbols. In such embodiments, a concrete length of the sequence may be defined by the first communication 406. In certain embodiments, a device specific sequence may be transmitted in a specific resource without data transmission following the device specific sequence. In one embodiment, the resource pool is device specific. In another embodiment, the resource pool may be shared by a device group. Due to good cross-correlation of a device specific sequence, the eNB 404 may separate each device's sequence if multiple devices transmit their respective sequence in the same resource simultaneously.

For contention based UL data transmission, the eNB 404 may not be aware of which device is transmitting data in one TTI so that it has to assume the existence of each device from the received signals then use successive interference cancellation (“SIC”) or message passing algorithm (“MPA”) algorithms to decode the devices one by one. Since a device specific sequence is unique within one cell, it may implicitly contain the device identification information. In certain embodiments, there may be three eNB 404 behaviors for responding to device specific sequence transmissions in embodiments involving contention based UL transmissions.

A first behavior is that the eNB 404 may determine the existence of one device by performing correlation of a device specific sequence with a received signal. In this way, blind detection complexity at the eNB 404 may be reduced. A second behavior is that the eNB 404 may determine the timing advance for one device after detecting the device's specific sequence which may indicate timing advance adjustment information in a DL channel. A third behavior is that the eNB 404 may know that the data following a device specific sequence is transmitted from the same device and may combine the received data with a previous version for retransmission combination. Accordingly, signaling overhead for a device may be reduced.

A third communication 410 may include data transmitted from the UE 402 to the eNB 404. In one embodiment, the data may be transmitted in a same TTI as the second communication 408. In another embodiment, a first portion of data may be transmitted in a first TTI as the second communication 408, and a second portion of data may be transmitted in one or more additional TTIs that follow the first TTI. In some embodiments, the third communication 410 and the second communication 408 may have the same bandwidth in the frequency domain.

A fourth communication 412 includes timing advance adjustment information from the eNB 404 to the UE 402 that may be transmitted in a field previously indicated as including timing advance adjustment information for the UE 402. The timing advance adjustment information may be determined by the eNB 404.

By performing transmissions as described herein a remove unit 102 specific sequence may be transmitted for configurations using contention based UL transmission. Moreover, common DCI information may be used for UL timing advance adjustment information for configurations using contention based UL transmission. As presented herein, UL synchronization may be maintained to facilitate interference at a base unit 104, and/or UL control signaling overhead may be reduced.

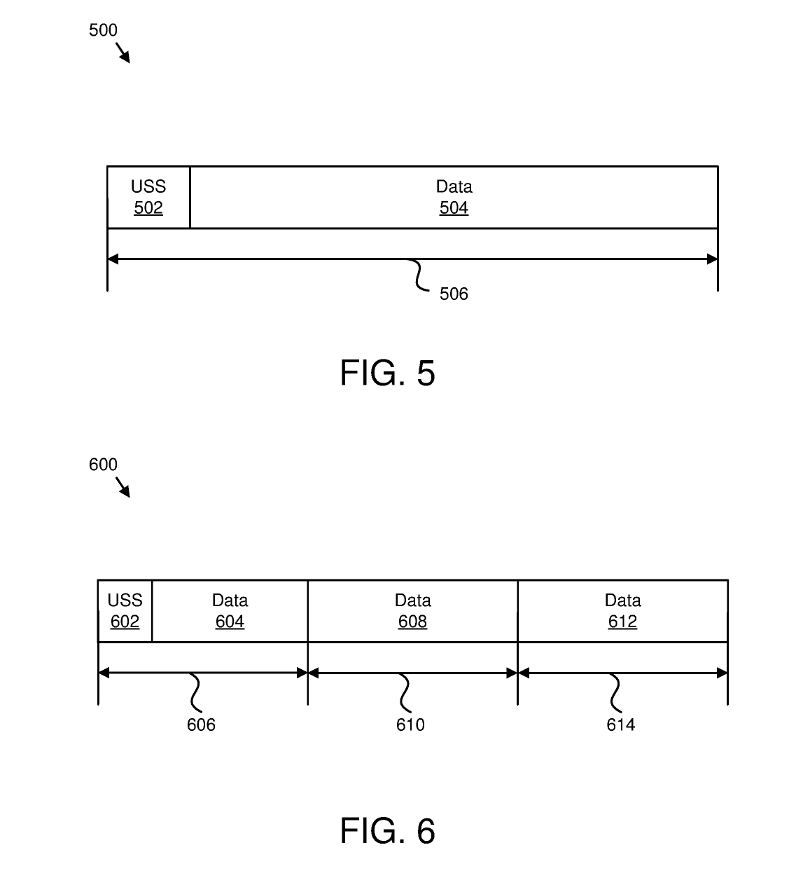

FIG. 5 illustrates one embodiment of uplink transmissions 500. Specifically, a UE specific sequence 502 (e.g., device specific sequence) is transmitted followed by data 504. The UE specific sequence 502 and the data 504 are transmitted in a same TTI 506. In some embodiments, no data 504 is transmitted after the UE specific sequence 502 is transmitted. Accordingly, in such embodiments, only the UE specific sequence 502 is transmitted in the TTI 506.

FIG. 6 is a schematic block diagram illustrating another embodiment of uplink transmissions 600. Specifically, a UE specific sequence 602 (e.g., device specific sequence) is transmitted followed by data 604. The UE specific sequence 602 and the data 604 are transmitted in a first TTI 606. Data 608 may be transmitted in a second TTI 608 following the first TTI 606. Moreover, data 612 may be transmitted in a third TTI 614 following the second TTI 610. As may be appreciated, any amount of data may be transmitted in TTIs following the first TTI 606. Moreover, each of the TTIs may have a same bandwidth in a frequency domain.

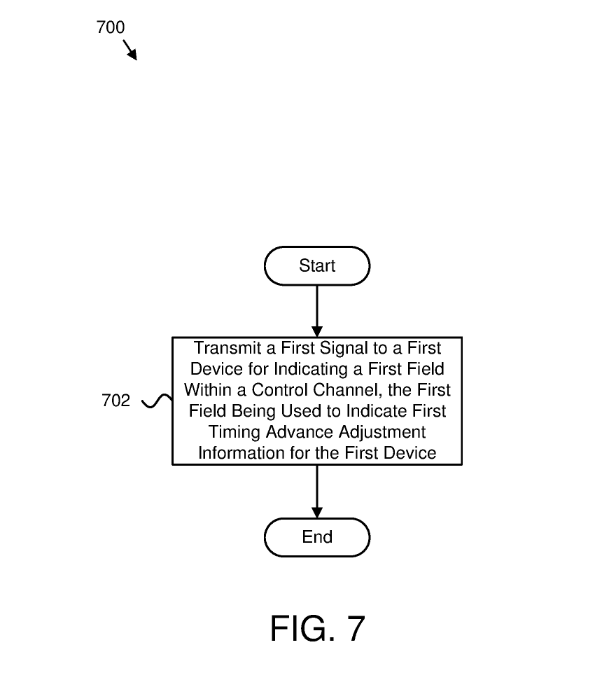

FIG. 7 is a schematic flow chart diagram illustrating one embodiment of a method 700 for timing advance adjustment communication. In some embodiments, the method 700 is performed by an apparatus, such as the base unit 104. In certain embodiments, the method 700 may be performed by a processor executing program code, for example, a microcontroller, a microprocessor, a CPU, a GPU, an auxiliary processing unit, a FPGA, or the like.

The method 700 may include transmitting 702 a first signal a first signal to a first device for indicating a first field within a control channel. In such an embodiment, the first field is used to indicate first timing advance adjustment information for the first device.

In one embodiment, the method 700 may include transmitting a second signal to a second device for indicating a second field within the control channel. In such an embodiment, the second field may be used to indicate second timing advance adjustment information for the second device. In a further embodiment, the method 700 may include receiving a sequence from the first device. In such an embodiment, the sequence may be a device specific sequence that distinguishes the first device from another device. In some embodiments, the sequence is generated based on an identification of the first device. In certain embodiments, the sequence occupies one symbol within a transmission time interval.

In some embodiments, the first device transmits data with the sequence in a transmission time interval. In various embodiments, the data and the sequence have a same bandwidth in a frequency domain. In certain embodiments, the first signal indicates the sequence. In one embodiment, the first signal indicates a resource pool for the first device to transmit the sequence. In some embodiments, the first device transmits the sequence on a resource of the resource pool. In various embodiments, the resource pool is shared by multiple devices.

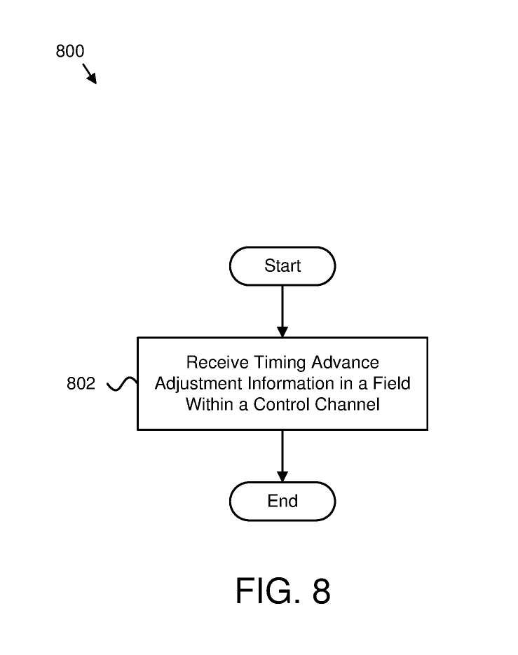

FIG. 8 is a schematic flow chart diagram illustrating one embodiment of a method 800 for timing advance adjustment communication. In some embodiments, the method 800 is performed by an apparatus, such as the remote unit 102. In certain embodiments, the method 800 may be performed by a processor executing program code, for example, a microcontroller, a microprocessor, a CPU, a GPU, an auxiliary processing unit, a FPGA, or the like.

The method 800 may include receiving 802 timing advance adjustment information in a field within a control channel.

In one embodiment, the method 800 includes receiving a signal indicating the field within the control channel. In a further embodiment, the signal indicates a sequence. In some embodiments, the signal indicates a resource pool for transmitting a sequence. In certain embodiments, the method 800 includes generating a sequence and transmitting the sequence based on the timing advance adjustment information. In such embodiments, the sequence is a device specific sequence that distinguishes a device from another device. In some embodiments, the sequence is generated based on an identification of the device.

In various embodiments, the method 800 includes transmitting the sequence on a resource of a resource pool. In one embodiment, the resource pool is shared by multiple devices. In certain embodiments, the sequence occupies one symbol within a transmission time interval. In some embodiments, the method 800 includes transmitting data with the sequence in a transmission time interval. In various embodiments, the data and the sequence have a same bandwidth in a frequency domain.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising:
a transmitter that transmits a first signal to a first device for indicating a first field within a control channel, wherein the first field is used to indicate first timing advance adjustment information for the first device.

2. The apparatus of claim 1, wherein the transmitter transmits a second signal to a second device for indicating a second field within the control channel, wherein the second field is used to indicate second timing advance adjustment information for the second device.

3. The apparatus of claim 1, further comprising a receiver that receives a sequence from the first device, wherein the sequence is a device specific sequence that distinguishes the first device from another device.

4. The apparatus of claim 3, wherein the sequence is generated based on an identification of the first device.

5. The apparatus of claim 3, wherein the sequence occupies one symbol within a transmission time interval.

6. The apparatus of claim 3, wherein the first device transmits data with the sequence in a transmission time interval.

7. The apparatus of claim 6, wherein the data and the sequence have a same bandwidth in a frequency domain.

8. The apparatus of claim 3, wherein the first signal indicates the sequence.

9. The apparatus of claim 3, wherein the first signal indicates a resource pool for the first device to transmit the sequence.

10. The apparatus of claim 9, wherein the first device transmits the sequence on a resource of the resource pool.

11. The apparatus of claim 9, wherein the resource pool is shared by multiple devices.

12. A method comprising:
transmitting a first signal to a first device for indicating a first field within a control channel, wherein the first field is used to indicate first timing advance adjustment information for the first device.

13. (canceled)

14. (canceled)

15. (canceled)

16. (canceled)

17. (canceled)

18. (canceled)

19. (canceled)

20. (canceled)

21. (canceled)

22. (canceled)

23. An apparatus comprising:
a receiver that receives timing advance adjustment information in a field within a control channel.

24. The apparatus of claim 23, wherein the receiver receives a signal indicating the field within the control channel.

25. The apparatus of claim 24, wherein the signal indicates a sequence.

26. The apparatus of claim 24, wherein the signal indicates a resource pool for transmitting a sequence.

27. The apparatus of claim 23, further comprising a processor that generates a sequence and a transmitter that transmits the sequence based on the timing advance adjustment information, wherein the sequence is a device specific sequence that distinguishes the apparatus from another device.

28. The apparatus of claim 27, wherein the sequence is generated based on an identification of the apparatus.

29. The apparatus of claim 27, wherein the transmitter transmits the sequence on a resource of a resource pool.

30. The apparatus of claim 29, wherein the resource pool is shared by multiple devices.

31. The apparatus of claim 27, wherein the sequence occupies one symbol within a transmission time interval.

32. The apparatus of claim 27, wherein the transmitter transmits data with the sequence in a transmission time interval.

33. The apparatus of claim 32, wherein the data and the sequence have a same bandwidth in a frequency domain.

34. A method comprising:
receiving timing advance adjustment information in a field within a control channel.

35. (canceled)

36. (canceled)

37. (canceled)

38. (canceled)

39. (canceled)

40. (canceled)

41. (canceled)

42. (canceled)

43. (canceled)

44. (canceled)
